(19) United States
(12) Patent Application Publication
(10) Pub. No.: US 2026/0310693 A1
(43) Pub. Date: Oct. 8, 2026

(54) OPERATING SYSTEM STATE CONTEXT MANAGEMENT

(71) Applicant: Microsoft Technology Licensing, LLC, Redmond, WA (US)

(72) Inventor: Justin James WAGLE, Pacifica, CA (US)

(73) Assignee: Microsoft Technology Licensing, LLC, Redmond, WA (US)

(21) Appl. No.: 19/171,093

(22) Filed: Apr. 4, 2025

(51) Int. Cl. G06F 16/3329; G06F 16/338; G06F 16/583

(52) U.S. Cl. CPC G06F 16/33295; G06F 16/338; G06F 16/583

(57) ABSTRACT

Implementations for operating system state (OS) context management are provided. One example includes a computing system comprising processing circuitry and memory storing instructions that, during execution, cause the processing circuitry to perform the steps of: receiving a query containing a request for information relating to a current OS state; passing the query to an artificial intelligence (AI) module; and generating an answer to the query by: calling an OS state retrieval tool to perform a plurality of application programming interface (API) calls to retrieve current OS state information; formatting the current OS state information into a data structure describing graphical window context that is readable by the AI module; and passing, to the AI module, the formatted current OS state information and a prompt containing instructions for answering queries using the formatted current OS state information.

### BACKGROUND

An operating system provides a platform for applications to run on a computing system. It can be implemented as a foundational software layer that acts as an intermediary between applications and physical hardware. The operating system manages and control computer hardware, performing tasks such as memory management and process scheduling. An operating system state refers to the context and conditions of the operating system at a given point in time. For example, the operating system state can include information such as active application windows and their contents.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Implementations for operating system state context management are provided. One example includes a computing system comprising processing circuitry and memory storing instructions that, during execution, cause the processing circuitry to perform the steps of: receiving a query containing a request for information relating to a current operating system state; passing the query to an artificial intelligence module; and generating an answer to the query by: calling an operating system state retrieval tool to perform a plurality of application programming interface calls to retrieve current operating system state information; formatting the current operating system state information into a data structure describing graphical window context that is readable by the artificial intelligence module; and passing, to the artificial intelligence module, the formatted current operating system state information and a prompt containing instructions for answering queries using the formatted current operating system state information.

### BRIEF DESCRIPTION OF THE DRAWINGS

FIG. 1 shows a schematic view of an example computing system for operating system state context management.

FIG. 2 shows an example graphical user interface for an operating system, which can be implemented using the example computing system of FIG. 1.

FIG. 3 shows a data flow diagram of an example method for operating system state context management, which can be implemented using the example computing system of FIG. 1.

FIG. 4 shows a data flow diagram of an example method for operating system state context management using two large language models, which can be implemented using the example computing system of FIG. 1.

FIG. 5 shows a process flow diagram of an example method for operating system state context management, which can be implemented using the example computing system of FIG. 1.

FIG. 6 shows a schematic view of an example computing environment in which the computer system of FIG. 1 may be enacted.

### DETAILED DESCRIPTION

Language models are a class of artificial intelligence (AI) systems that leverage deep learning techniques and architectures to analyze, understand, and generate language input/output using probability distribution over words. Language models are generally trained on large datasets of text, enabling them to perform a wide range of tasks, including but not limited to text prediction, language generation, language translation, summarization, question answering, and various other natural language processing tasks. Language models can be implemented in various ways. For example, some language models are implemented using generative pretrained transformers.

Language models can be implemented in various sizes with varying numbers of parameters. Smaller models often provide faster processing and lower costs while larger models can provide more accurate responses. Generally, a large language model (LLM) refers to a language model with a large number of parameters, which can range from millions to trillions. The capabilities of LLMs to understand and generate language depend on their training dataset. With a robust dataset, LLMs can provide powerful question-answering capabilities relating to general information. However, LLMs typically lack the ability to answer personalized questions without appropriate pre-training, grounding, or a conversation history as context.

In view of the observations above, implementations of operating system (OS) state context management for LLMs are provided. OS state context can be managed in various ways for use by LLMs. In some implementations, the OS state is managed in an external memory module. Tools and various application programming interface (API) calls to the OS can be utilized to generate OS state information. OS state information describes user activity and, as such, can be utilized to answer personalized questions relating to the user and their computer activity. OS state information can include but is not limited to information describing active application windows, most recently opened application, historical application activity, date, time, etc. Applying such information for use in an LLM can provide a grounding that the LLM can use for reasoning and to provide appropriate answers to relevant queries. The grounding provides context that allows queries and answers to refer to aspects of the user's computer activity, such as an application name, contents of an application, the user's activity, etc. For example, a user may query an LLM about their previous or current computer activity while referencing a specific application that the user is/was using. In response, the LLM can retrieve the OS state and utilize it as grounding to understand the referenced application and to generate an accurate answer.

OS state information can be retrieved in various ways. While a user operates a computing device, the state of the OS changes constantly. For example, the state of the OS can change as the user opens, navigates, and closes various applications. Tools can be used to track window screens, and information such as application name, window title, etc. can be recorded. In some implementations, screen understanding techniques and API calls to the operating system are utilized to determine current OS state information. In further implementations, the OS state information can be formatted into an appropriate data structure that can be parsed and read by an LLM.

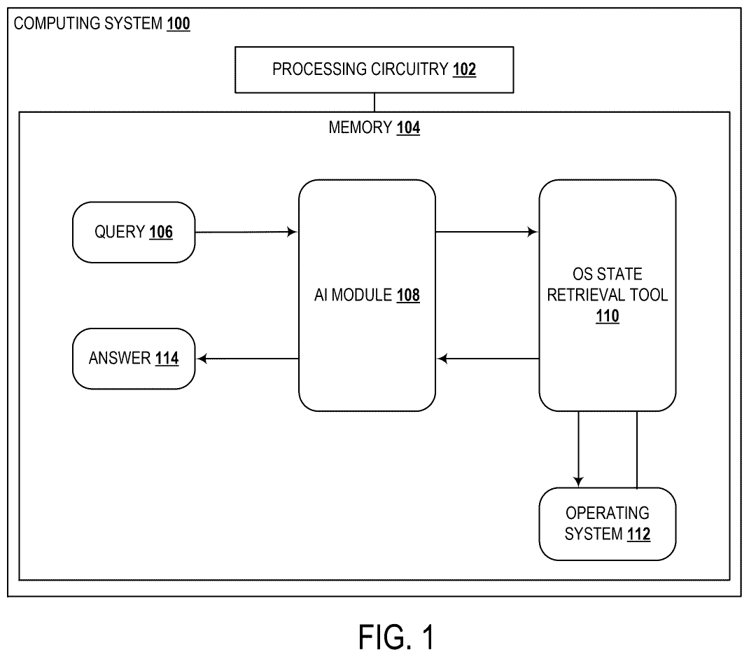

Turning now to the drawings, implementations of operating system state context management for LLMs are depicted and described in further detail. FIG. 1 shows a schematic view of an example computing system 100 for operating system state context management. The example computing system 100 includes processing circuitry 102 and memory 104 storing instructions that, during execution, cause the processing circuitry 102 to perform the processes described herein. The example computing system 100 can be implemented with one or more of various types of computing devices, including but not limited to personal computers, servers, and mobile devices. For example, the computing system 100 can include a plurality of computing devices, and processing circuitry 102 and memory 104 may each include multiple components spread across multiple computing devices (e.g., processing circuitry 102 can include multiple processors within a single device or spread across multiple devices). The devices may be locally and/or remotely located. The example computing system 100 can also include non-depicted components for providing various functionalities, including components on individual computing devices.

The example computing system 100 implements an OS state context management system capable of tracking and providing OS state information for use in answering a query 106 provided by a user. The example computing system 100 can receive the query in various ways. In some implementations, the query 106 is provided by user input through an input device such as a keyboard device. The query 106 is passed to an AI module 108 for inference. In the depicted example, the query 106 includes a request for information relating to a current OS state. For example, the query 106 can include a request asking about content with which the user was interacting. The user may be browsing a website, reading a document, writing/editing a document, preparing a slide presentation, etc. Queries may involve content across multiple applications. For example, a query can request a comparison of text content in one application window with another application window. A query can also request information by referring to application windows and their content by name. For example, the query can request a summary of an article by referring to its title. Such information can be included in the OS state, which can be retrieved and utilized by the AI module 108 to understand the query 106.

The AI module 108 reasons that the query 106 includes a request relating to information that the current OS state can provide. In response, the AI module 108 attempts to retrieve the current OS state. The current OS state can be retrieved in various ways. In the depicted example, the AI module 108 utilizes an OS state retrieval tool 110 to provide the current OS state. During a user session where the user operates a computing device, the state of the OS can change as the user performs different actions. For example, application windows can be opened, navigated, closed, reordered, etc. The OS state retrieval tool 110 includes various components for tracking such information.

The OS state retrieval tool 110 can be implemented in various ways. In some implementations, the OS state retrieval tool 110 performs a plurality of API calls to the OS 112 to retrieve OS state information. The AI module 108 can be provided with a list of available tools and functions along with instructions on how and when to utilize them. For example, such information can be provided in the form of an LLM prompt. Oftentimes, the OS 112 provides native support and functionalities for retrieving the OS state information. For example, operating systems generally provide access to certain OS state information through a command-line interface (e.g., “who” command for providing user information, “ps” command for providing information about an active process, “top” command for providing a table of processes, etc.). In a more specific example, WINDOWS™ (an OS provided by Microsoft Corporation, a company headquartered in Redmond, Washington) includes an infrastructure that provides a set of extensions for software and system components to access and manage information about the state of the OS (e.g., Windows Management Instrumentation).

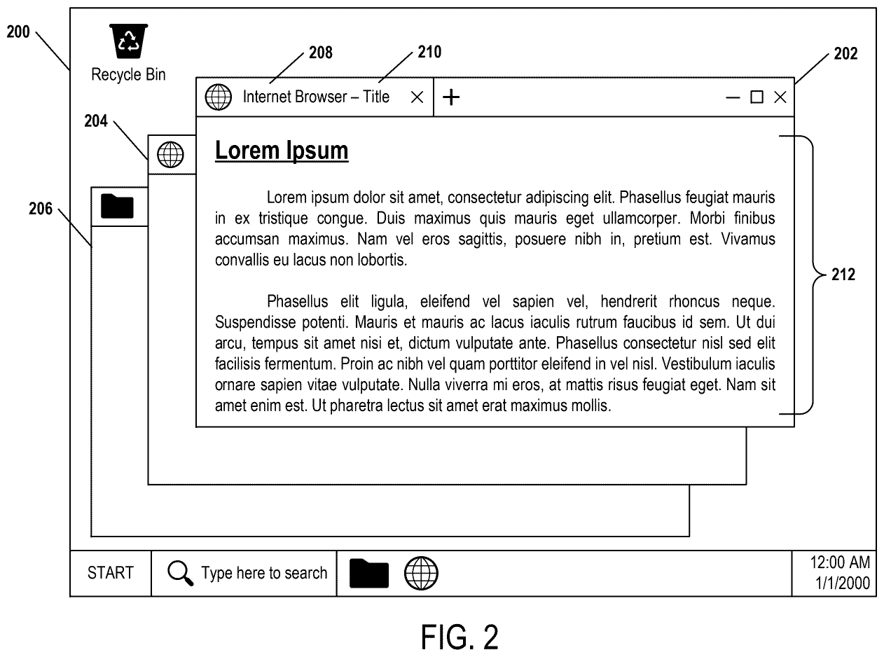

OS state information describes various aspects of the OS state, such as active application windows, timing of activity on application windows (e.g, when and how long an application has been running), order of application windows (e.g., frontmost, backmost, etc.), historical application activity (e.g., closed applications), application names (e.g., specific web browsers, word processing applications, presentation applications, etc.), content within applications (e.g., article title, body text, images, etc.), date and time settings, screenshot images, images of the application windows, etc. Such information can be retrieved using various methods, including those described above. For example, browser information can be retrieved from the accessibility tree. In some implementations, the OS retrieval tool 112 utilizes the graphical screen and extracts information using computer vision techniques. FIG. 2 depicts an example of different OS state information that can be retrieved.

FIG. 2 shows an example graphical user interface (GUI) 200 for an operating system. The OS GUI 200 can be implemented in, for example, the computing system 100 of FIG. 1. In the depicted example of FIG. 2, three application windows are currently opened, including a first internet browser application window 202, a second internet browser application window 204, and a file explorer window 206. Various aspects of the OS state can be tracked and recorded. For example, the OS state information can include information describing that there are three active application windows along with their ordering and information on the most recent active application window (e.g., topmost application window). Other aspects, such as application name 208, content title 210, and content 212, can also be tracked and recorded.

OS state information can be used to provide a grounding for an AI module, such as the AI module 108 of FIG. 1, to answer queries relating to a current OS state. For example, a user may query an AI module to summarize the content 212 of the first internet browser application window 202. The query may refer to the content 212 in various ways, which may be understood by the AI module using the tracked OS state information (such as those described above). In the depicted example, a query may refer to the content 212 of the first internet browser application window 202 by the content title 210, by the application name 208, or by referencing the “topmost” application window. Queries may also reference aspects across multiple application windows. For example, a query may request a comparison of information between the content of the first internet browser application window 202 and the content of the second internet browser application window 204.

Referring back to FIG. 1, the retrieved OS state information can be passed to the AI module 108. For efficiency and readability, the OS state information can be formatted in a data structure that the AI module 108 can parse and understand. In some implementations, the OS state retrieval tool 110 formats the retrieved OS state information into such a data structure. The formatted OS state information can then be passed to the AI module 108. Various types of data structures can be defined. For example, the data structure can be defined to hold only text. In other examples, the data structure includes both text and images.

In addition to passing the formatted OS state information to the AI module 108, a prompt containing instructions for answering queries using the formatted OS state information can also be passed. The prompt can describe instructions for reading/parsing/interpreting the formatted OS state information. For example, the prompt can include instructions for parsing the data structure, describing the meaning of various nomenclatures and syntax. In some implementations, the prompt includes instructions on the relevancy of various aspects of the OS state information. For example, the prompt can describe how the ordering of application windows is relevant. In another example, the prompt can describe that the most recent active application window has the most relevancy. The prompt can be generated in various ways. In some implementations, the prompt is predefined, and the same prompt is passed to the AI module 108 for each query. In some implementations, the OS state retrieval tool 110 generates the prompt. Different prompts can be generated depending on the OS state information. For example, the OS state information may include image data, and the prompt can be generated accordingly to provide instructions on how to handle image data.

As can readily be appreciated, implementations of the various components for formatting the retrieved OS state information and the generating prompts can exist outside of the OS state retrieval tool 110. For example, the formatting component and/or the prompt generation component can be implemented as independent software modules in the example computing system 100. In some implementations, the functions of such components are handled by the AI module 108. For example, the AI module 108 can format the OS state information into an appropriate data structure and/or generate an appropriate prompt.

Using the formatted OS state information and the prompt, the AI module 108 reasons and provides an answer 114 to the query 106. The AI module 108 can be implemented as a chat agent that provides question answering capabilities. The user may follow up with further queries, and the AI module 108 repeats the process. In some implementations, the current OS state is retrieved for each query that is determined to include a request for information relevant to the OS state. As the OS state may change during a user session, retrieval of the current OS state rather than using previous OS state information can be advantageous.

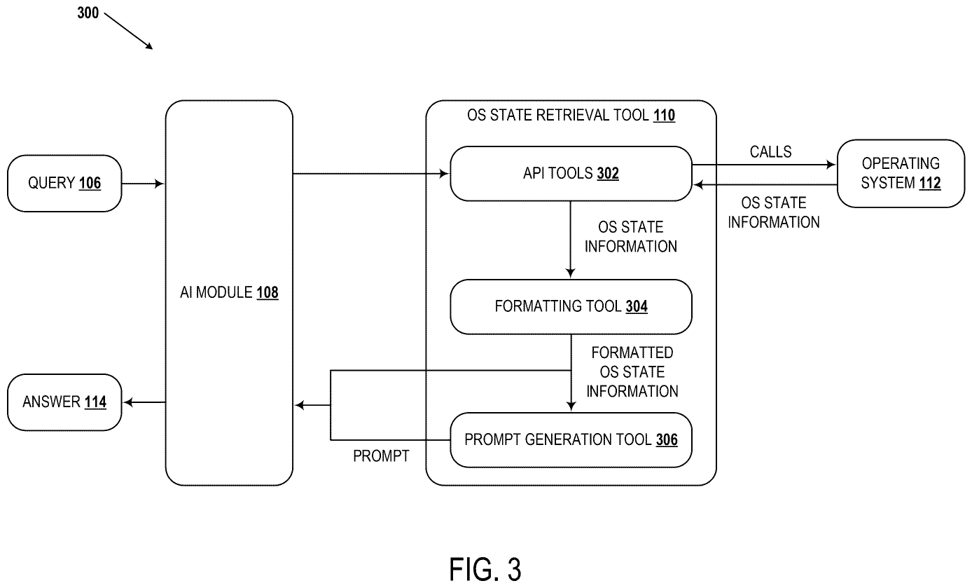

FIG. 1 provides an example architecture of an OS state context management system. The processes described can be implemented logically in various ways. FIG. 3 shows a data flow diagram of an example method 300 for operating system state context management. The process starts with receiving a query 106, which is passed to an AI module 108. In the depicted example, the AI module 108 determines that the query 106 includes a request for information relating to a current OS state. In response, the AI module 108 calls upon an OS state retrieval tool 110 to retrieve current OS state information.

The OS state retrieval tool 110 includes various components for retrieving current OS state information. In the depicted example, the OS state retrieval tool 110 includes a plurality of API tools 302. Each of the API tools 302 respectively performs an API call to the OS 112 to retrieve current OS state information. For example, API calls to retrieve application window statuses, such as currently active application windows, their application name and contents, etc., can be performed. The retrieved current OS state information can then be formatted into a data structure that can be read and parsed by the AI module 108. Various types of data structures can be defined and implemented. For example, the data structure can specify syntax, file header structures, and nomenclatures. In the depicted example, the OS state retrieval tool 110 includes a formatting tool 304 for formatting the retrieved current OS state information into the desired data structure. In some implementations, the formatting tool 304 concatenates the retrieved current OS state information and, if necessary, make changes to ensure that they adhere to the data structure format.

The formatted OS state information can be passed to the AI module 108. To provide context, a prompt containing instructions on how to answer queries using the formatted OS state information can be provided. In some implementations, a predetermined prompt is utilized and provided for each query. In the depicted example, the OS state retrieval tool 110 includes a prompt generation tool 306 that generates an appropriate prompt using the formatted OS state information. For example, if the formatted OS state information includes image data, the prompt generation tool 306 may generate a prompt containing instructions on how to handle the image data. In further examples, the prompt can describe instructions on performing optical character recognition (OCR) on the image data and how to further process the data (e.g., using the text extracted by OCR in combination with the formatted OS state information to answer queries).

FIGS. 1 and 3 depict and describe use of an AI module 108 for evaluating queries using OS state information retrieved by an OS state retrieval tool 110. The AI module 108 can be implemented in various ways. For example, the AI module 108 may include one or multiple models. The type of models utilized can depend on the implementation of the OS state context management system. For example, if the system is configured to retrieve image data as part of the OS state information, the AI module 108 can include a multi-modal model, such as a vision-language model, to process such data. In some implementations, the AI module 108 includes a single large language model. For example, the AI module 108 can be implemented using a single LLM that receives and answers the query 106, which can be performed by retrieving OS state information through the OS state retrieval tool 110.

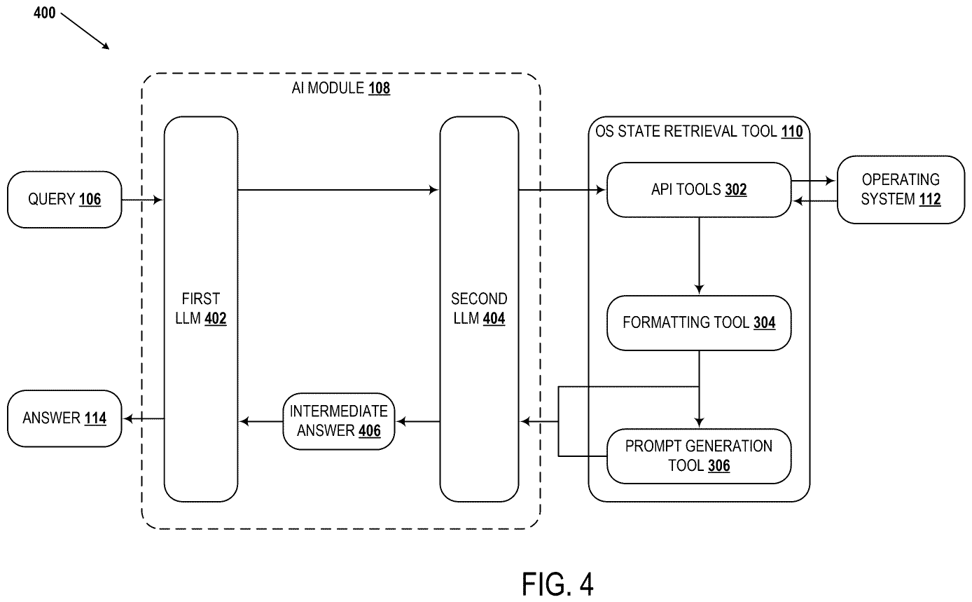

In some implementations, the AI module 108 includes at least two large language models. The use of two large language models provides several advantages. FIG. 4 shows a data flow diagram of an example method 400 for operating system state context management using an AI module 108 that includes two large language models 402, 404. The process starts with receiving a query 106 that is passed to the first LLM 402. The first LLM 402 determines that the query 106 includes a request for information relating to a current OS state. In response, the first LLM 402 calls upon the second LLM 404 to answer the query 106.

The second LLM 404 can be implemented in various ways to answer the query 106. In the depicted example, the second LLM 404 calls upon an OS state retrieval tool 110 to retrieve current OS state information, which can provide grounding for answering the query 106. The OS state information retrieval process can be implemented similarly to the processes described above with respect to FIG. 3. For example, the OS state retrieval tool 110 can utilize a plurality of API tools 302 to perform API calls to the OS 112 to retrieve current OS state information. In some implementations, the second LLM 404 is provided with a list of tools and functions along with instructions on how and when to utilize them to retrieve the current OS state information. A formatting tool 304 can be used to format the retrieved OS state information into a data structure that can be read and parsed by the second LLM 404. Additionally, the OS state retrieval tool 110 can include a prompt generation tool 306 to generate an appropriate prompt using the formatted OS state information. The formatted OS state information and the prompt can be passed to the second LLM 404, which utilizes such information as grounding to generate an intermediate answer 406 to the query 106. The second LLM 404 passes the intermediate answer 406 to the first LLM 402, which reformats it (if necessary) into a final answer output 114 to the query 106.

The use of two LLMs and the separation of their tasks provide several advantages. One advantage includes enabling the first LLM 402 to retain more conversation history within its context window. LLMs are built and implemented with various technical limitations, which includes a context window. If one LLM was implemented to provide question answering capabilities with a user in addition to utilizing OS state context as grounding for answering queries, the OS state information may push past conversation history outside the context window. This reduces the LLM's capability to provide an efficient chat agent that can provide answers to multiple related queries.

The AI module architecture of FIG. 4 utilizes two LLMs 402, and 404 to enable an effective chat agent while compartmentalizing the query answering using OS state information as grounding. In some implementations, the second LLM 404 is a stateless LLM. The first LLM 402 provides a chat agent interface with the user while the second LLM 404 retrieves and utilizes the current OS state information to answer the provided query. Accordingly, the answer output of the second LLM 404 is an intermediate answer 406 that can be reformatted by the first LLM 402. For example, as the second LLM 404 may be unaware of the conversation history between the user and the first LLM 402, its answer output may contain inaccuracies or redundant information. In such cases, the first LLM 402 can reformat the intermediate answer 406 or, if necessary, calls upon the second LLM 404 to address any underlying issue.

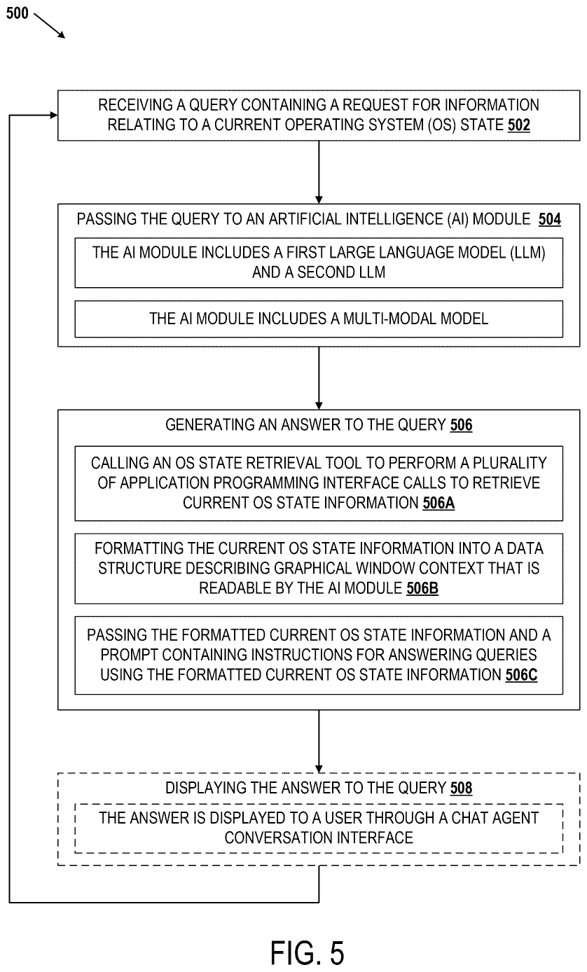

FIG. 5 shows a process flow diagram of an example method 500 for operating system state context management. The example method 500 includes, at step 502, receiving a query. The query can include a request for information relating to a current OS state. For example, the query can include a request to summarize text in the current OS state, such as text in an open document or a webpage. The query can also request processing of information between or among multiple locations. For example, the query can request a comparison of content between two or more application windows.

The example method 500 includes, at step 504, passing the query to an artificial intelligence module. The AI module can be implemented in various ways. In some implementations, the AI module includes a first large language model. The query can be passed to the first LLM. In some implementations, the first LLM outputs an answer to the query using the current OS state information. For example, the query may request information relating to the current OS state. In such cases, the AI module may determine that information relating to the current OS state can be helpful in answering the query. In response, the AI module attempts to retrieve the current OS state information to utilize as OS grounding to generate an answer to the query. By utilizing such information as grounding, the LLM can understand queries that reference specific applications and their contents related to the OS state, which is generally associated with the user providing the query. For example, a user operating a computing device during a user session may open, navigate, and close various applications. The user may query the LLM for information related to the applications. Utilizing information relating to the current OS state, the LLM can understand queries that reference the applications involved during the user sessions.

In some implementations, the AI module also includes a first LLM and a second LLM. In such cases, the first LLM may call upon the second LLM to answer the query using OS state context management. This allows the first LLM to maintain a context window that includes more conversation history with the user. In some implementations, the second LLM is stateless. The AI module can also implement various other types of models, including but not limited to multi-modal models. For example, a vision-language model can be implemented to utilize OS state information that includes both text and image data.

The example method 500 includes, at step 506, generating an answer to the query. Generating the answer to the query can be performed in various ways. Substeps 506A-506C describe one example. In response to the AI module determining that current OS state information can be utilized as OS grounding to generate an answer to the query, the example method 500 includes, at substep 506A, calling an OS state retrieval tool to perform a plurality of application programming interface calls to retrieve current OS state information. Various types of OS state information can be retrieved. In some implementations, the OS state information describes active application windows in the current OS state. In some implementations, the OS state information includes image data. For example, a screenshot image or portion thereof can be retrieved. Images of application windows can also be retrieved. Other types of OS state information can include but is not limited to information describing timing of activity on application windows, order of application windows, historical application activity, application names, content within applications, date and time settings, etc.

At substep 506B, the example method 500 includes formatting the current OS state information into a data structure describing graphical window context that is readable by the AI module. The formatting can be performed in various ways. In some implementations, the OS state retrieval tool includes a formatting tool that formats the current OS state information into the defined data structure. In other implementations, the AI module includes a component for formatting the current OS state information. Various types of data structures can be defined. For example, the data structure can specify syntax, file header structures, and nomenclatures. In some implementations, the data structure can be defined to hold only text. In other implementations, the data structure can include both text and images.

At substep 506C, the example method 500 includes passing the formatted current OS state information and a prompt to the AI module. The prompt includes instructions for answering queries relating to the current OS state. For example, the prompt can include instructions describing how to interpret certain syntax rules and nomenclatures of the defined data structure. In some implementations, the prompt provides information describing the relevancy of certain OS state information. The prompt can, for example, describe that the order of application windows is relevant in answering the prompt and/or that the topmost application window is most relevant. The prompt can be generated in various ways. In some implementations, the prompt is predetermined and is provided to the AI module in response to every query. In some implementations, the OS state retrieval tool includes a prompt generation tool that generates an appropriate prompt. The prompt can be generated based on the formatted OS state information. For example, if the formatted OS state information includes image data, the prompt can include instructions for processing such data (e.g., instructions to perform OCR on the image data and further processing). The AI module then utilizes the formatted current OS state information and the prompt to generate an answer to the query.

In some implementations, the AI module includes a first LLM that generates the answer to the query. The first LLM can generate the answer to the query in various ways. As described above with respect to step 504, the first LLM can call upon a second LLM to answer the query. This allows the first LLM to keep its context window clean from the OS state information. Using OS state context management, the second LLM can generate an intermediate answer and return it to the first LLM. For example, the second LLM can perform substeps 506A-506C as described above. The intermediate answer can be formatted into a final answer to the query that is provided to the user. For example, in cases where the second LLM is stateless, the intermediate answer may not be optimal. The first LLM can utilize conversational history to supplement and format the intermediate answer into a more accurate answer.

The example method 500 optionally includes, at step 508, displaying the answer to the query. In some implementations, the query is provided as part of a conversation between a user and a chat agent (e.g., the first LLM). Further queries can be provided as part of the conversation. In such cases, the example method 500 of FIG. 5 can be performed again in response to each query.

In some embodiments, the methods and processes described herein may be tied to a computing system of one or more computing devices. In particular, such methods and processes may be implemented as a computer-application program or service, an application-programming interface (API), a library, and/or other computer-program product.

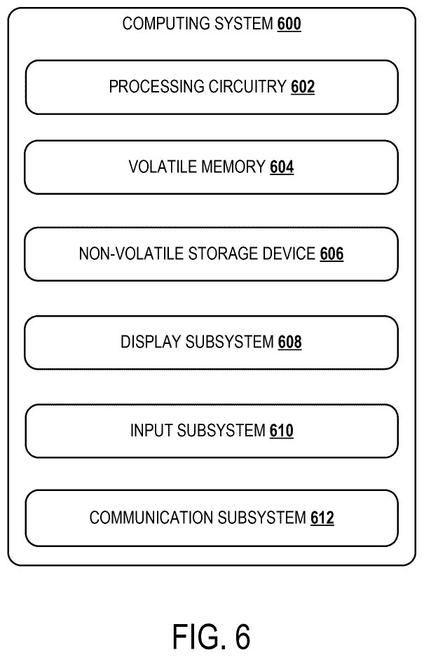

FIG. 6 schematically shows a non-limiting embodiment of a computing system 600 that can enact one or more of the methods and processes described above. Computing system 600 is shown in simplified form. Computing system 600 may embody the computing system 100 described above and illustrated in FIG. 1. Components of computing system 600 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 600 includes processing circuitry 602, volatile memory 604, and a non-volatile storage device 606. Computing system 600 may optionally include a display subsystem 608, input subsystem 610, communication subsystem 612, and/or other components not shown in FIG. 6.

Processing circuitry 602 includes a logic processor that can be implemented with one or more physical devices configured to execute instructions. For example, the processing circuitry 602 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The processing circuitry 602 may include one or more physical processors configured to execute software instructions. Additionally or alternatively, the processing circuitry 602 may include one or more hardware logic circuits or firmware devices configured to execute hardware-implemented logic or firmware instructions. Processors of the processing circuitry 602 may be single-core or multi-core, and the instructions executed thereon may be configured for sequential, parallel, and/or distributed processing. Individual components of the processing circuitry 602 optionally may be distributed among two or more separate devices, which may be remotely located and/or configured for coordinated processing. Aspects of the processing circuitry 602 may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the processing circuitry 602 to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by processing circuitry 602 to temporarily store information during processing of software instructions. It will be appreciated that volatile memory 604 typically does not continue to store instructions when power is cut to the volatile memory 604.

Aspects of processing circuitry 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via processing circuitry 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with processing circuitry 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

The following paragraphs provide additional description of the subject matter of the present disclosure. One example includes computing system for operating system (OS) state context management, the computing system comprising: processing circuitry and memory storing instructions that, during execution, cause the processing circuitry to perform the steps of: receiving a query containing a request for information relating to a current OS state; passing the query to an artificial intelligence (AI) module; and generating an answer to the query by: calling an OS state retrieval tool to perform a plurality of application programming interface (API) calls to retrieve current OS state information; formatting the current OS state information into a data structure describing graphical window context that is readable by the AI module; and passing, to the AI module, the formatted current OS state information and a prompt containing instructions for answering queries using the formatted current OS state information, wherein the formatted current OS state information and the prompt is used by the AI module to generate the answer to the query. In this example, additionally or alternatively, the AI module comprises a first large language (LLM) model, wherein passing the query to the AI module comprises passing the query to the first LLM, and wherein generating the answer to the query comprises generating the answer to the query using the first LLM. In this example, additionally or alternatively, the AI module further comprises a second LLM, and wherein the generating the answer to the query using the first LLM comprises: calling, via the first LLM, the second LLM to answer the query; generating and passing, via the second LLM, an intermediate answer to the first LLM, wherein the intermediate answer is generated using the formatted current OS state information and the prompt; and formatting, via the first LLM, the intermediate answer into the answer to the query. In this example, additionally or alternatively, the OS state retrieval tool is called by the second LLM. In this example, additionally or alternatively, the second LLM is stateless. In this example, additionally or alternatively, the AI module comprises a multi-modal LLM. In this example, additionally or alternatively, the data structure of the current OS state information comprises image data. In this example, additionally or alternatively, the image data comprises screenshot image data. In this example, additionally or alternatively, the data structure of the current OS state information comprises information relating to active application windows in the current OS state. In this example, additionally or alternatively, the request for information is related to at least two of the active application windows in the current OS state.

Another example includes a method for operating system (OS) state context management, the method comprising: receiving a query containing a request for information relating to a current OS state; passing the query to an artificial intelligence (AI) module; and generating an answer to the query by: calling an OS state retrieval tool to perform a plurality of application programming interface (API) calls to retrieve current OS state information; formatting the current OS state information into a data structure describing graphical window context that is readable by the AI module; and passing, to the AI module, the formatted current OS state information and a prompt containing instructions for answering queries using the formatted current OS state information, wherein the formatted current OS state information and the prompt is used by the AI module to generate the answer to the query. In this example, additionally or alternatively, the AI module comprises a first large language (LLM) model, wherein passing the query to the AI module comprises passing the query to the first LLM, and wherein generating the answer to the query comprises generating the answer to the query using the first LLM. In this example, additionally or alternatively, the AI module further comprises a second LLM, and wherein the generating the answer to the query using the first LLM comprises: calling, via the first LLM, the second LLM to answer the query; generating and passing, via the second LLM, an intermediate answer to the first LLM, wherein the intermediate answer is generated using the formatted current OS state information and the prompt; and formatting, via the first LLM, the intermediate answer into the answer to the query. In this example, additionally or alternatively, the OS state retrieval tool is called by the second LLM. In this example, additionally or alternatively, the second LLM is stateless. In this example, additionally or alternatively, the AI module comprises a multi-modal LLM. In this example, additionally or alternatively, the data structure of the current OS state information comprises image data. In this example, additionally or alternatively, the image data comprises screenshot image data. In this example, additionally or alternatively, the data structure of the current OS state information comprises information relating to active application windows in the current OS state.

Another example includes a method for operating system (OS) state context management, the method comprising: receiving, via a first large language model (LLM), a query; determining, via the first LLM, that the query contains a request for information relating to a current OS state; performing, via the first LLM, a function call to a second LLM to answer the query; calling, via the second LLM, an OS state retrieval tool to perform a plurality of application programming interface (API) calls to retrieve current OS state information; formatting the current OS state information into a data structure describing graphical window context that is readable by the second LLM; passing, to the second LLM, the formatted current OS state information and a prompt containing instructions for answering queries using the formatted current OS state information; generating, via the second LLM, an intermediate answer to the query using the formatted current OS state information and the prompt; passing the intermediate answer to the query to the first LLM; reformatting, via the first LLM, the intermediate answer into an answer to the query; and displaying the answer to the query.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for operating system (OS) state context management, the computing system comprising:
processing circuitry and memory storing instructions that, during execution, cause the processing circuitry to perform the steps of:
receiving a query containing a request for information relating to a current OS state;
passing the query to an artificial intelligence (AI) module; and
generating an answer to the query by:
calling an OS state retrieval tool to perform a plurality of application programming interface (API) calls to retrieve current OS state information;
formatting the current OS state information into a data structure describing graphical window context that is readable by the AI module; and
passing, to the AI module, the formatted current OS state information and a prompt containing instructions for answering queries using the formatted current OS state information, wherein the formatted current OS state information and the prompt is used by the AI module to generate the answer to the query.

2. The computing system of claim 1, wherein the AI module comprises a first large language (LLM) model, wherein passing the query to the AI module comprises passing the query to the first LLM, and wherein generating the answer to the query comprises generating the answer to the query using the first LLM.

3. The computing system of claim 2, wherein the AI module further comprises a second LLM, and wherein the generating the answer to the query using the first LLM comprises:
calling, via the first LLM, the second LLM to answer the query;
generating and passing, via the second LLM, an intermediate answer to the first LLM, wherein the intermediate answer is generated using the formatted current OS state information and the prompt; and
formatting, via the first LLM, the intermediate answer into the answer to the query.

4. The computing system of claim 3, wherein the OS state retrieval tool is called by the second LLM.

5. The computing system of claim 3, wherein the second LLM is stateless.

6. The computing system of claim 1, wherein the AI module comprises a multi-modal LLM.

7. The computing system of claim 6, wherein the data structure of the current OS state information comprises image data.

8. The computing system of claim 7, wherein the image data comprises screenshot image data.

9. The computing system of claim 1, wherein the data structure of the current OS state information comprises information relating to active application windows in the current OS state.

10. The computing system of claim 9, wherein the request for information is related to at least two of the active application windows in the current OS state.

11. A method for operating system (OS) state context management, the method comprising:
receiving a query containing a request for information relating to a current OS state;
passing the query to an artificial intelligence (AI) module; and
generating an answer to the query by:
calling an OS state retrieval tool to perform a plurality of application programming interface (API) calls to retrieve current OS state information;
formatting the current OS state information into a data structure describing graphical window context that is readable by the AI module; and
passing, to the AI module, the formatted current OS state information and a prompt containing instructions for answering queries using the formatted current OS state information, wherein the formatted current OS state information and the prompt is used by the AI module to generate the answer to the query.

12. The method of claim 11, wherein the AI module comprises a first large language (LLM) model, wherein passing the query to the AI module comprises passing the query to the first LLM, and wherein generating the answer to the query comprises generating the answer to the query using the first LLM.

13. The method of claim 12, wherein the AI module further comprises a second LLM, and wherein the generating the answer to the query using the first LLM comprises:
calling, via the first LLM, the second LLM to answer the query;
generating and passing, via the second LLM, an intermediate answer to the first LLM, wherein the intermediate answer is generated using the formatted current OS state information and the prompt; and
formatting, via the first LLM, the intermediate answer into the answer to the query.

14. The method of claim 13, wherein the OS state retrieval tool is called by the second LLM.

15. The method of claim 13, wherein the second LLM is stateless.

16. The method of claim 11, wherein the AI module comprises a multi-modal LLM.

17. The method of claim 16, wherein the data structure of the current OS state information comprises image data.

18. The method of claim 17, wherein the image data comprises screenshot image data.

19. The method of claim 11, wherein the data structure of the current OS state information comprises information relating to active application windows in the current OS state.

20. A method for operating system (OS) state context management, the method comprising:
receiving, via a first large language model (LLM), a query;
determining, via the first LLM, that the query contains a request for information relating to a current OS state;
performing, via the first LLM, a function call to a second LLM to answer the query;
calling, via the second LLM, an OS state retrieval tool to perform a plurality of application programming interface (API) calls to retrieve current OS state information;
formatting the current OS state information into a data structure describing graphical window context that is readable by the second LLM;
passing, to the second LLM, the formatted current OS state information and a prompt containing instructions for answering queries using the formatted current OS state information;
generating, via the second LLM, an intermediate answer to the query using the formatted current OS state information and the prompt;
passing the intermediate answer to the query to the first LLM;
reformatting, via the first LLM, the intermediate answer into an answer to the query; and
displaying the answer to the query.
